(19) United States
(12) Patent Application Publication
(10) Pub. No.: US 2008/0202345 A1
(43) Pub. Date: Aug. 28, 2008

(54) Machine for the Production of a Coffee-Based Drink

(76) Inventor: Giuseppe Delonghi, Treviso (IT)

Correspondence Address: GOTTLIEB RACKMAN & REISMAN PC, 270 MADISON AVENUE, 8TH FLOOR, NEW YORK, NY, 10016-0601, US

(21) Appl. No.: 11/916,777

(22) PCT Filed: Mar. 24, 2006
(86) PCT No.: PCT/EP2006/002723

§ 371 Date: Dec. 6, 2007

(30) Foreign Application Priority Data
Jun. 29, 2005 (IT) MI2005A001224

(51) Int. Cl. A47J 31/00; G05B 19/00; A47J 31/44

(52) U.S. Cl. 99/280

(57) ABSTRACT

The machine for the production of a coffee-based drink comprises a software management system of a hardware system having detection means of one or more variations of the physical state of said machine and/or alimentary products useful in its operation.

As is known, the present machines for the production of a coffee-based drink, and in particular the coffee machines of automatic and semi-automatic type, offer the user a plurality of functions, and consequently must be capable of carrying out a multiplicity of operations.

This fact implies that the electrical circuit part, as well as the kinetic part, is of considerable importance and, consequently, its development considerably affects the final cost of the machine in addition to increasing its size and weight.

For this reason, many coffee machines have a limited number of control system of their static and dynamic parts and, in the case they have them, such systems are always rather complex both from the application and functional point of view.

For example, the microswitches are still highly used, particularly in the machine's dynamic parts, adapted to open or close the different electrical circuits.

The use of infrared rays is also known, above all in the static parts of the machine, to detect the presence or lack thereof of useful products for the realisation of the coffee drink, such as coffee beans.

Nevertheless, these devices are also rarely used due to their costs.

Consequently, from that stated above, in a present coffee machine, the control of the costs of the size, weight, energetic consumption and operation quality have determined an extremely limited application of control devices of the static and dynamic parts.

Such lack causes numerous drawbacks for the user, who is not informed or pre-informed regarding anomalies which may take place during the machine operation or during its inactivity, with all of the effects which may result from this situation.

Often, in fact, such anomalies cause the sudden stopping of the machine during its operation (for example during the preparation of one or more cups of coffee or cappuccino) with a consequent loss of time for machine restart and, sometimes, discarding of the coffee-based drink obtained since it has poor organoleptic characteristics.

Furthermore, the partial or total lack of control systems negatively affects the optimisation of the electrical energy consumption, the coffee's organoleptic optimisation due to the variable type of the powder granulometry of the same, the extent of the grounds' compression, the quantity used, the water temperature and so on.

The technical task proposed by the present invention is therefore that of realising a machine for the production of a coffee-based drink which permits eliminating the noted technical drawbacks of the prior art.

In the scope of the this technical task, one object of the invention is that of realising a machine for the production of a coffee-based drink which has limited costs, size and reduced weight while ensuring maximum control of all its static and dynamic parts.

Another object of the invention is that of realising a machine for the production of a coffee-based drink which is free from undesired stops and, therefore, does not cause useless wastes of time.

Still object of the invention is that of realising a machine for the production of a coffee-based drink which ensures a consistent, high-quality operation over time.

Not the last object of the invention is that of realising a machine for the production of a coffee-based drink which permits optimising the electrical energy consumptions and the coffee's organoleptic properties.

This technical task, as well as these and other objects, are achieved according to the present invention by realising a machine for the production of a coffee-based drink, characterised in that it comprises a software management system of a hardware system having detection means of one or more variations of the physical state of said machine and/or alimentary products useful in its operation.

Other characteristics of the present invention are moreover defined in the subsequent claims.

Further characteristics and advantages of the invention will be more evident from the description of a preferred but not exclusive embodiment of a machine for the production of a coffee-based drink, according to the finding, illustrated as indicative and not limiting in the attached drawings, wherein:

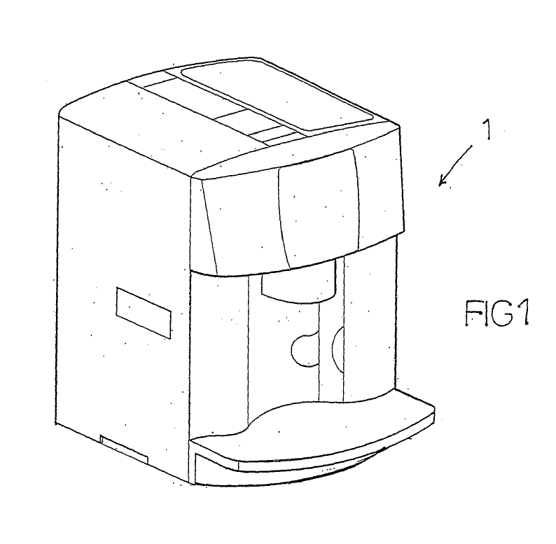

FIG. 1 shows an overall view of the machine according to the finding;

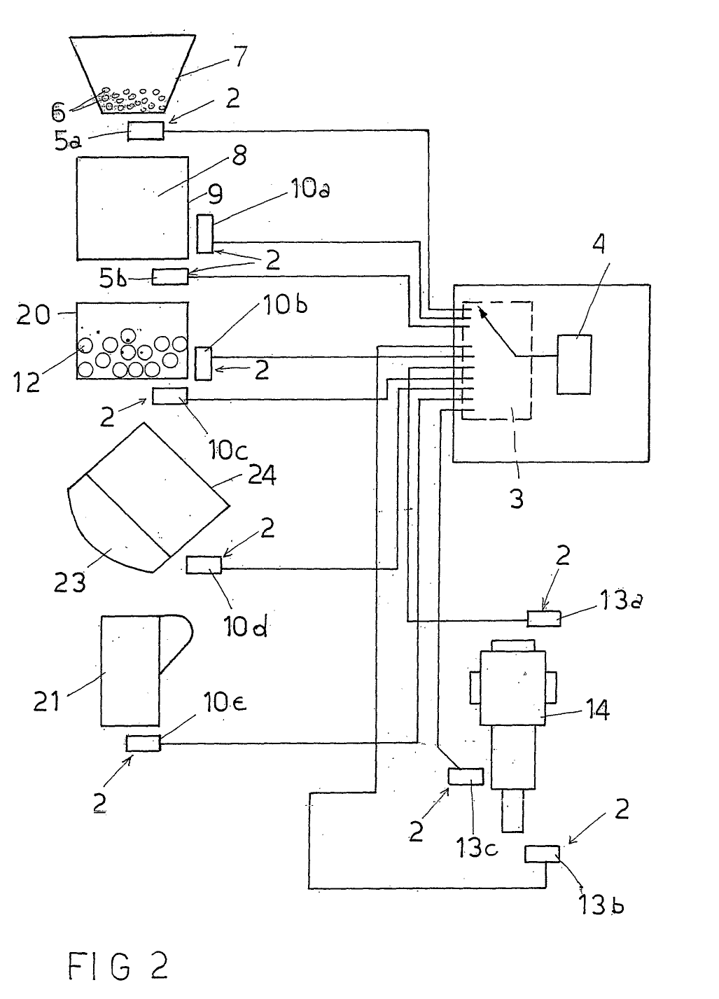

FIG. 2 schematically shows the positioning of the capacitive probes for monitoring the static and/or dynamic parts of the machine according to the finding.

With reference to the mentioned figures, a machine is shown for the production of a coffee-based drink, indicated in its entirety with 1, which may be of automatic or semi-automatic type and which comprises a software management system of a hardware system having detection means of one or more variations of the physical state of said machine and/or alimentary products useful for its operation.

Advantageously, the detection means comprise capacitive sensors 2, elements capable of modifying their capacity (Farad) in relation with the presence or lack thereof of solid and/or liquid material placed near them.

Furthermore, the machine software manages an electronic circuit 3 capable of controlling multiple sensors 2 through successive interrogations of the same, so to permit controlling a high number of inputs with a single dedicated integrated circuit 4.

For example, the electronic device 3 may be a Multiplexer (MUX).

In particular, inside the coffee machine, the capacitive sensors 2 are defined by first capacitive sensors adapted to preferably but not unequivocally detect the presence of the alimentary products useful for its operation, such as the presence of coffee beans 6 inside the containment tank 7 of the same (sensor 5a), the presence of water 8 in its tank 9 (sensor 5b), possibly milk in the frother, the presence of sugar and still other items.

Second capacitive sensors are also present which preferably but not unequivocally detect the physical state of said machine, or the presence and/or correct positioning of the various elements which make up the machine, such as the presence of the water 8 tank 9 (sensor 10a), the presence of the container 20 of the coffee grounds 12 (sensor 10c), the presence and/or level which the grounds 12 have reached in the same (sensor 10b), the presence of the accessories 21 applied to said machine (sensor 10e), for example for the realisation of milk froth, tea, long coffee, and alimentary products which are soluble in hot water.

The second capacitive sensors also detect the level of the water 23 inside the recovery tub 24 of the same (sensor 10d) and the correct closure of the access door inside the machine (sensor not shown).

The capacitive sensors 2 also comprise third capacitive sensors adapted to the control of the kinetic motions of the machine and in particular at least detect the stopping of the upper part of the infuser group 14 (sensor 13a), the stopping of the bottom part of the infuser group 14 (sensor 13b), the presence or lack thereof of the extractable infuser group 14 and the control of its correct insertion inside said machine (sensor 13c).

Advantageously, the sensors 2 also have at least fourth capacitive sensors (not shown) adapted to the control of the ground coffee powder granulometry.

In this case, the software manages the grinding grinder (not shown) of the coffee in relation with the granulometry value, increasing or decreasing its grinding time.

The capacitive sensors also comprise at least fifth capacitive sensors (not shown) adapted to detect the quality of the water inside the tank so to indicate if the water has been in the tank for a long period and if it has lost its potability.

Appropriately, the machine's electronic circuit is capable of interrogating the capacitive sensors one at a time or one predetermined sensor at a time according to a predetermined sequential nature or else substantially simultaneously interrogating all the capacitive sensors.

The software is therefore adapted to optimise the energy consumption and confer the maximum flexibility of use to the capacitive sensors, preventing undesired stops of the machine by means of alarm or pre-alarm signals.

Keeping in mind the low cost of use of the capacitive sensors and the reduced size of the circuit part pertaining to these, it is obvious that the same may also be used in other functions. For example, they may detect the presence or lack thereof of the cup or its size in relation with the selected quantity of coffee. Clearly, the possibility to check multiple states of the machine will be very advantageous, for example for automatic or semi-automatic built-in machines where for every fill up or supplement, the user must extract the machine from the space where it lies.

It has been established in practice how the machine for the production of a coffee-based drink, according to the invention, is particularly advantageous so to offer the user a very high level of control of its static and dynamic components, and possible accessories with which it is equipped.

The coffee machine thus conceived is susceptible to numerous modifications and variations, all falling within the scope of the inventive concept; furthermore all details may be substituted with technically equivalent elements.

In practice, the materials utilised, as well as the size, may be of any type according to needs and the state of the art.

1. Machine for the production of a coffee-based drink, characterised in that it comprises a software management system of a hardware system having detection means of one or more variations of the physical state of said machine and/or alimentary products useful for its operation.

2. Machine according to claim 1, characterised in that said detection means comprise capacitive sensors.

3. Machine according to one or more of the previous claims, characterised in that it comprises an electronic circuit capable of controlling multiple sensors by means of successive interrogations of the same so to permit controlling a high number of inputs with a single dedicated integrated circuit.

4. Machine according to one or more of the previous claims, characterised in that said electronic circuit is a multiplexer.

5. Machine according to one or more of the previous claims characterised in that said capacitive sensors comprise first and second capacitive sensors.

6. Machine according to one or more of the previous claims, characterised in that said first capacitive sensors preferably but not unequivocally detect the presence of alimentary products useful for its operation.

7. Machine according to one or more of the previous claims, characterised in that said second capacitive sensors preferably but unequivocally detect the physical state of said machine.

8. Machine according to one or more of the previous claims, characterised in that said capacitive sensors comprise at least third capacitive sensors adapted to the control of the kinematic motion of said machine.

9. Machine according to one or more of the previous claims, characterised in that said capacitive sensors comprise at least fourth capacitive sensors adapted to the control of the ground coffee powder granulometry, said software being adapted to manage the grinding grinder of said coffee in relation with the value of said granulometry.

10. Machine according to one or more of the previous claims, characterised in that said capacitive sensors comprise at least fifth capacitive sensors adapted to detect the quality of the water contained in the collected water tub.

11. Machine according to one or more of the previous claims, characterised in that said first capacitive sensors at least detect the presence of the coffee beans inside the containment tank of the same, the presence and the level of the water inside the tank and the presence of liquids or additional products such as milk or sugar and still others.

12. Machine according to one or more of the previous claims, characterised in that said second capacitive sensors at least detect the presence of the water tank, the presence of the coffee grounds container and the level of the coffee grounds, the level of the water in the water collection tub, the presence of the accessories applied to said machine, for example for the realisation of milk froth, tea, long coffee, and alimentary products which are soluble in hot water.

13. Machine according to one or more of the previous claims, characterised in that said third capacitive sensors at least detect the stopping of the upper part of the infuser group, the stopping of the bottom part of the infuser group, the presence of the extractable infuser group, the control of its correct insertion inside said machine.

14. Machine according to one or more of the previous claims, characterised in that said electronic circuit interrogates said capacitive sensors one at a time.

15. Machine according to one or more of the previous claims, characterised in that said electronic circuit interrogates one predetermined sensor at a time.

16. Machine according to one or more of the previous claims, characterised in that said electronic circuit substantially simultaneously interrogates said capacitive sensors.

17. Machine according to one or more of the previous claims, characterised in that said software is adapted to optimise the electrical energy consumption and confer the maximum flexibility of use to said capacitive sensors.
